(19) United States
(12) Patent Application Publication
(10) Pub. No.: US 2014/0046760 A1
(43) Pub. Date: Feb. 13, 2014

(54) METHODS, SYSTEMS, AND COMPUTER READABLE MEDIA FOR IDENTIFYING QUALIFYING CONSUMER OFFERS

(71) Applicant: Robert A. Keogh, Epping (AU)

(72) Inventor: Robert A. Keogh, Epping (AU)

(73) Assignee: INDEPENDENT MOBILE MEDIA AUSTRALASIA PTY LTD, Epping (AU)

(21) Appl. No.: 13/591,716

(22) Filed: Aug. 22, 2012

(30) Foreign Application Priority Data
Aug. 7, 2012 (AU) AU2012211389

(51) Int. Cl. G06Q 30/02

(52) U.S. Cl. 705/14.53

(57) ABSTRACT

This disclosure concerns the identification of qualifying consumer offers. In one example, the identification is performed by a server. The server first receives an electronic graphical representation of purchase information and extracts from the graphical representation text data elements relating to the purchase. The server then matches the text data elements to criteria of one or more consumer offers to identify qualifying offers, such that predetermined criteria of the qualifying offer is successfully matched to the data elements. Finally, the server sends or displays to the consumer information relating to the qualifying consumer offers. Identifying offers that a purchase qualifies for is automatic, and more efficient and less costly to deliver. Commonly used receipts can be used as purchase information and there is no requirement for the receipt to contain any particular notation. This makes the method agnostic to the retailer.

### CROSS-REFERENCE TO RELATED APPLICATION

This application claims priority under 35 U.S.C. §119(a) to Australian Patent Application No. 2012211389, filed Aug. 7, 2012. The entire contents of this application are hereby incorporated by reference herein.

### TECHNICAL FIELD

This disclosure concerns the identification of qualifying consumer offers. In particular, the invention concerns, but is not limited to, methods, computer readable media and computer systems for identifying qualifying consumer offers.

### BACKGROUND ART

A wide range of offers are available to most consumers, such as purchasing two items for less than the two items cost separately. However, the process of claiming the rewards of the offers is often tedious for the consumer and therefore the business process is not efficient.

### DISCLOSURE OF INVENTION

In a first aspect there is provided a computer-implemented method for identifying qualifying consumer offers, the method comprising:
(a) receiving an electronic graphical representation of purchase information;
(b) extracting from the graphical representation text data elements relating to the purchase;
(c) matching the text data elements to criteria of one or more consumer offers to identify qualifying offers, such that predetermined criteria of the qualifying offer is successfully matched to the data elements; and
(d) sending or displaying to the consumer information relating to the qualifying consumer offers.

It is an advantage of the method that identifying offers that the customer's purchase qualifies for is automatic, and in turn more efficient and less costly to deliver. It is an advantage that commonly used receipts can be used as purchase information. That is, there is no requirement for the receipt to contain any particular notation to be used by this method. Text that is already used on a receipt to make it readily human understandable is automatically extracted and used by this method. This makes the method agnostic to the retailer. A retailer's receipts can be used with this method without the retailer specifically registering or making any modification to their receipts to participate. In this way, the offers can be centred on the actual products or services.

Step (b) can comprise automatically extracting text data elements using a template that identifies the relative location of the text data elements in the graphical representation.

It is an advantage of this embodiment that the method has prior knowledge of the likely location of relevant information in the graphical representation. This makes step (b) more accurate and better able to process low quality graphical representations.

The template can be specific to the retailer that originally produced the purchase information. The template can be specific to the type of graphical representation of the purchase information.

The data elements can include two or more of:
retailer,
specific store,
operator that assisted with purchase,
point of sale used,
time,
one or more products or services purchased,
one or more price of products or services purchases,
total purchase value,
consumer identifier, and
geo-location reference.

In a second aspect there is provided tangible and non-transitory computer-readable media, that when read by a computer causes the computer perform the method of the first aspect.

In a third aspect there is provided a computer system for identifying qualifying consumer offers, the system comprising:
an input port adapted and configured to receive an electronic graphical representation of purchase information;
a processor adapted and configured to extract from the graphical representation text data elements relating to the purchase and to match the text data elements to criteria of one or more consumer offers to identify qualifying offers, such that predetermined criteria of the qualifying offer is successfully matched to the data elements; and
an output port adapted and configured to send or a display adapted and configured to display to the consumer information relating to the qualifying consumer offers.

In a fourth aspect there is provided a computer-implemented method for identifying qualifying consumer offers, the method comprising:
(a) capturing a graphical representation of purchase information, the graphical representation having extractable text data elements relating to the purchase;
(b) sending the graphical representation to a third party; and
(c) if the text data elements match predetermined criteria of a consumer offer, receiving information relating to the consumer offer.

Step (a) can comprise taking a photograph of the purchase information.

Steps (a), (b) and (c) can be performed by the same portable device.

The purchase information can be a printed receipt showing itemised text based information relating to the purchase of goods or services.

If the text data elements match only some of the predetermined criteria of a further consumer offer, the method can comprise the further step of receiving information relating to the further consumer offer and an indication of the predetermined criteria no yet met.

In a fifth aspect there is provided tangible and non-transitory computer-readable media, that when read by a computer causes the computer to perform the method of the fourth aspect.

In a sixth aspect there is provided a computer system for identifying qualifying consumer offers, the system comprising:
an image sensor adapted and configured to capture a graphical representation of purchase information, the graphical representation having extractable text data elements relating to the purchase;
an output port adapted and configured to send the graphical representation to a third party; and
an input port adapted and configured to receive information relating to the consumer offer if the text data elements match predetermined criteria of a consumer offer.

Optional features of one embodiment of one aspect, where appropriate, are also optional features of the other aspects of the invention.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 is a block diagram of a communication system.

FIG. 2a is a block diagram of a method for identifying qualifying consumer offers as performed by a consumer device.

FIG. 2b is a block diagram of a method for identifying qualifying consumer offers as performed by a central server.

FIG. 3 is a tabular representation of an exemplary text data element relating to a purchase.

FIG. 4 is a tabular representation of a criteria of a consumer offer.

FIG. 5a is a sample user interface displayed on a consumer device.

FIG. 5b is a further sample user interface displayed on a consumer device.

### BEST MODE FOR CARRYING OUT THE INVENTION

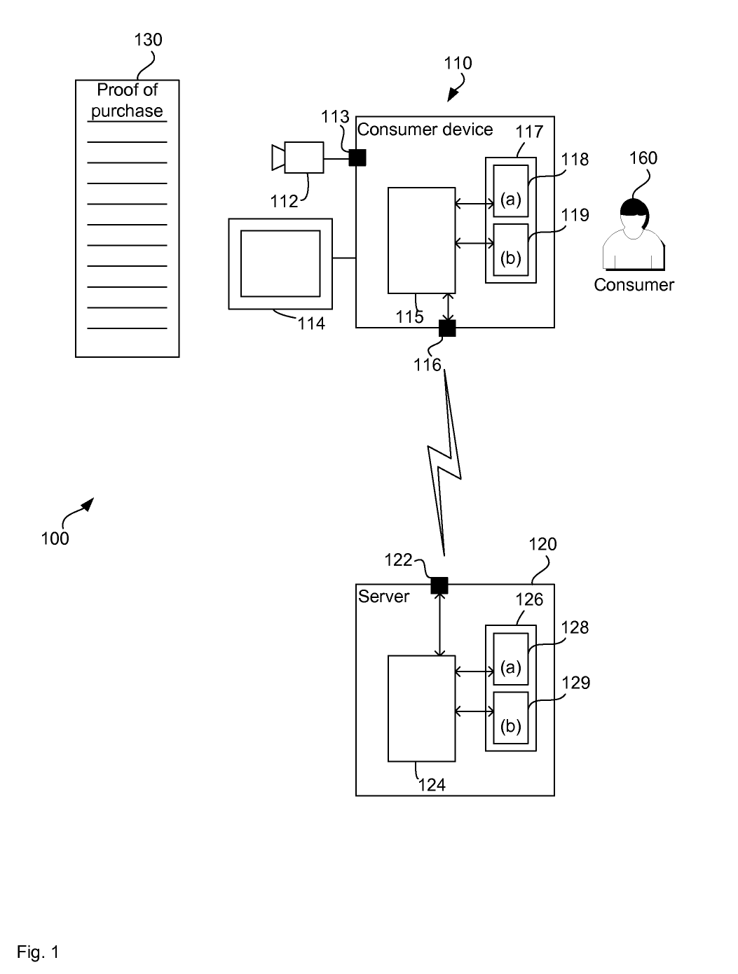

FIG. 1 illustrates a communication system 100 comprising a consumer device 110 with a camera 112 connected to the consumer device 110 via input port 113 and a display 114 operated by a consumer 160. The user device further has a processor 115, an input/output port 116 that allows the consumer device 110 to communicate with server 120 below and a memory 117 comprising data memory 118 and software memory 119. The consumer device 110 can be a mobile communication device, such as a smart phone, or an ordinary personal computer (PC) connected to a USB webcam or other image sensors, such as a scanner. The consumer device 110 can be equipped to send an image captured by the image sensor via email through input/output port 116. The consumer device 110 has installed software in software memory 119 that when executed by the processor 115 of the consumer device 110 causes the consumer device 110 to operate in the matter described here. In one example, where the consumer device 110 is a smart phone the consumer 160 operates the consumer device 110 by use of an app that is installed on the consumer device 110 and that provides a convenient graphical user interface for this specific purpose.

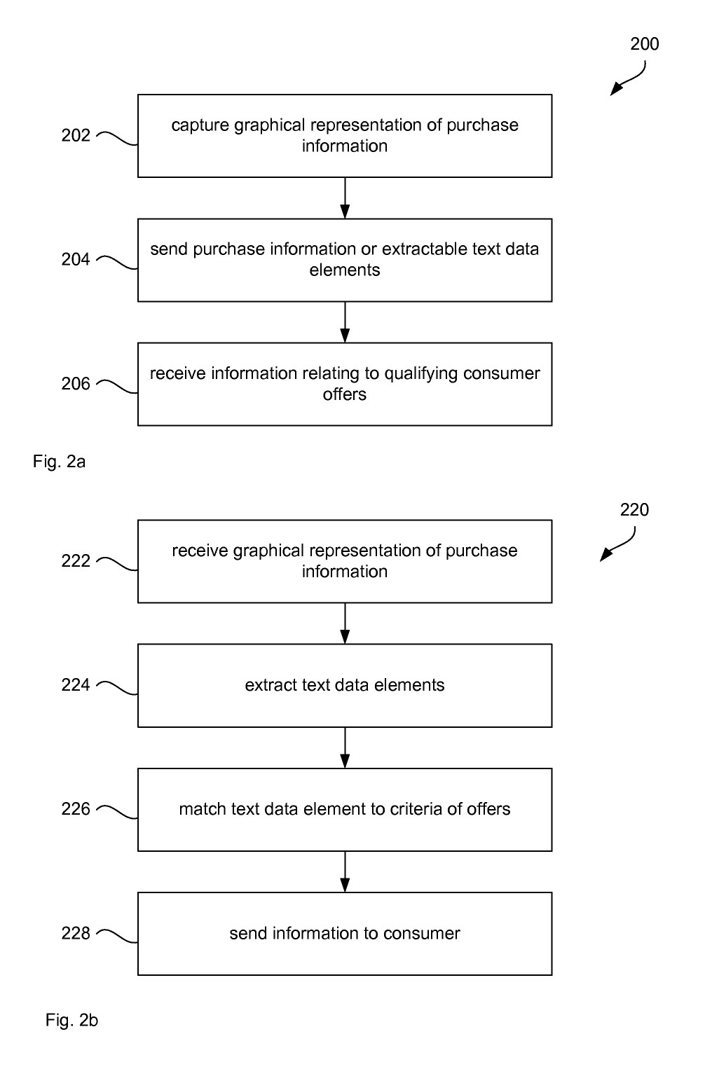

A person skilled in the art would appreciate that many arrangements of a processor, memory, input/output port could support the performance of the method 200 set out in FIG. 2a.

The consumer device 110 is connected via a communication link 118 to a server 120 for identifying qualifying consumer offers. The communication link 118 can be via a cellular data network, wireless local area network, LTE, WIMAX®, BLUETOOTH®, Internet or any combination of these and other wire-based and wireless communication techniques.

The server 120 comprises an input/output port 122, a processor 124 and a memory 126 including data memory 128 and program memory 129. The server 120 can be a single computer, one of multiple virtual machines on a shared server, a cloud service or any other system providing data processing capabilities.

The consumer 160 has an account with the server 120; that is the server 120 can identify the consumer 160 when the consumer 160 communicates with server 120. The server 120 stores on data memory 128 purchase information templates, criteria of consumer offers, consumer account information, such as an account balance associated with the consumer 160, and information related to offers that the consumer has claimed previously and consumer status. The consumer 160 can access the account information using the consumer device 110.

The consumer 160 learns about an offer through information provided by the consumer device 110 or through other channels, such as advertising. The consumer 160 decides to purchase products from that offer and therefore makes a purchase from a retailer. The retailer provides to the consumer 160 purchase information 130, such as a printed receipt from a check out register. The printed receipt 130 comprises a list of products in an itemised form, such that each item contains text based information relating to the purchase.

Typically, each product is given a description in alphanumeric characters that readily identifies to the consumer the product, an alphanumeric unique code, a number representing the quantity purchased and the cost of the product. The text based information is any alphanumeric information included on the receipt, such as store name, location and time of purchase and the information related to the purchased products as described above. It is noted here that although the invention is explained with reference to a purchased product, the invention is equally applicable to other purchased goods or services.

FIG. 2a illustrates a method 200 for identifying qualifying consumer offers as performed by a consumer device 110. The consumer 160 points the camera 112 of the consumer device 110 to the purchase information 130 such that the consumer device 110 captures 202 a graphical representation of the purchase information 130. To facilitate this process the display 114 of the consumer device 110 shows a live view of the image that the camera 112 will capture. The consumer 160 confirms when the camera 112 is in position and then the camera 112 of the consumer device 110 captures an image, that is takes a photograph that forms the electronic graphical representation of the purchase information 130.

In one example, the consumer device 110 processes the captured image, such as by converting the captured image into a greyscale image, adjusting brightness levels and cropping the image such that the image only contains the information printed on the receipt 130. The consumer device 110 then sends 204 the processed image to a third party, such as the server 120.

FIG. 2b illustrates a method 220 for identifying qualifying consumer offers as performed by server 120, that is processor 124 executes program code that is stored on program memory 129 to perform method 220. In different examples, the method 220 is performed by user device 110 itself or any other computing device in communication with user device 110.

The server 120 receives 222 an electronic graphical representation of purchase information from a consumer and the electronic graphical representation has text captured that can be extracted as text data elements relating to the purchase. In this example, the electronic graphical representation is an image of a sales receipt captured by camera 112 and processed by user device 110 as described earlier. The image can be received via a TCP connection, through a web service API, as an email attachment, as an SMS or MMS, via a fax service or any other electronic communication method.

The server 120 extracts 224 from the graphical representation text data elements relating to the purchase. In this example, the extraction step 224 comprises optical character recognition OCR, intelligent character recognition or other image recognition system engines. The output of the recognition is a set of extracted text element (text fields) with each text field being associated with a physical location on the receipt.

The server 120 can have stored on data memory one or more templates that identify the relative location of the text data elements in the graphical representation, that is in the image of the receipt. For example, a template contains the information that the name of the retailer is within an area located at 5 mm from the top and 2 mm from the left of the receipt and that the address of the retailer is 3 mm below the name of the retailer. The measurements can be different in different units than millimeters, such as pixels and relative to the width of the receipt as captured in the graphical representation to reduce errors based on different image dimensions.

The server 120 uses these templates to automatically extract text data elements; that is the server 120 retrieves the text from the image within the area specified by the template to extract the respective text data element. The server 120 can extract the name of the retailer without using a template, such as by using image recognition that identifies the retailer logo regardless of where the logo is located on the receipt. The server 120 can also receive from the user device the name of the retailer. The server 120 uses the extracted name to select the associated template that contains relative locations of text data elements on receipts from that retailer. As a result, the template is specific to the retailer that originally produced the purchase information. Further, the template can be specific to the type of graphical representation, that is whether it is a photographic image, a scanned image or a fax or whether it as a jpg, png, tiff or other type of graphical representation.

In other examples, the server 120 operates to extract data elements without use of a template. In this case, the content of the extracted data elements is compared to known content, either specific so that particular strings are identified or content satisfying particular criteria. For example, the characters to the right of a dollar sign represent the purchase price or alphanumeric text of more than 10 characters to the left of a dollar sign is the description of the product. Over time, patterns identified in data elements of the same retailer can be used to dynamically create or update a template.

In one example, an operator of the server 120 assists in extracting the text data elements by specifying the areas where the text data elements are located on the image. This manual validation processes trains an auto-learning component thereby reducing automatic validation durations over time achieving greater efficiencies.

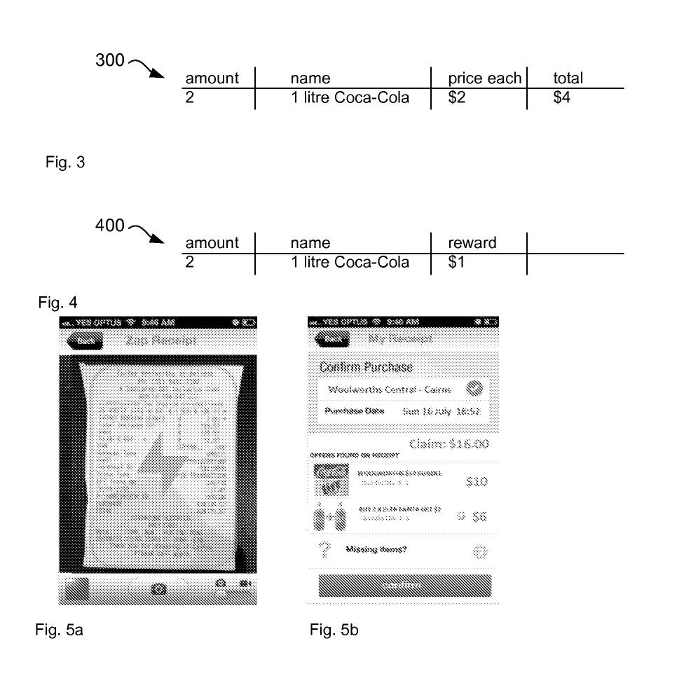

In one example, each line on the receipt represents one purchased product. In that case the text fields are combined, such that one text data element is extracted for each purchased product. The text data element contains multiple data sub-elements, such as amount, product name, price per unit, number of units purchased and total price. FIG. 3 illustrates an exemplary text data element 300 relating to the purchase. In this example, the consumer 160 has purchased two one litre bottles of Coca-Cola for $2 each resulting in a total price of $4.

The method 220 then matches 226 the text data element 300 to criteria of one or more consumer offers. FIG. 4 illustrates a criteria 400 of a consumer offer. In this example, the consumer receives a reward of $1 if the consumer buys two one litre bottles of Coca-Cola. In other examples, the consumer offer is a bundle of different products that need to be purchased in order to receive the reward. The offer can also have a time range during which the offer is available, within which the product must be purchased or an expiry date. The offer can be limited to purchases from a single retailer, such as supermarket chain Woolworths or to a specific store or branch. In another example, the offer includes a criteria for an operator that assisted with the purchase or the point of sale that was used.

In yet another example, the criteria can include the price of the products, such that an offer is only valid if the price of the product is above a certain threshold to exclude already reduced products from the offer. In a further example, the offer is available to only some consumers and therefore, the offer criteria includes a consumer identifier, a set of consumer identifiers or a status associated with a consumer identifier. This can be used where an offer is only available to consumers who have spent a minimum amount over the previous month or otherwise qualify for a premium status. In yet a further example, the criteria include a geo-location reference, such as the retailer's address, in order to limit the offer to certain regions or to display other offers to the consumer that are specific to that location. These criteria are successfully matched to the data elements if the data elements meet the criteria.

In yet another example, the criteria of a consumer offer is simply a minimum amount the consumer needs to spend in order to receive the reward, such as a minimum amount of $20 at Woolworths is rewarded by a rebate of $0.05 per litre of fuel the next time the user uses a fuel station. In that example, the entitlement to the reduced fuel price is stored on the server 120 and when the consumer at a later stage captures the receipt from the fuel station, $0.05 per litre are credited to the consumer's account.

Typically, server 120 stores on data store 128 one or more consumer offers and the server matches the text data element from the consumer's purchase information to the criteria of the consumer offers. This way the server identifies qualifying offers, such that the predetermined criteria of the qualifying offer is successfully matched to the data elements. In the example of FIGS. 3 and 4, the server 120 matches the text data element in FIG. 3 to the consumer offer in FIG. 4, such that the consumer offer 400 is determined as a qualifying offer if the amount of the text data element 300 is greater or equal to the amount in the consumer offer 400 and the names of the text data element 300 and the consumer offer 400 are exactly the same.

In some examples, the consumer offer can be matched multiple times, such as where the amount in the text data element 300 is a multiple of the amount in the consumer offer 400. In other examples, a successful match includes a part match, that is a part of the condition is fulfilled and the condition can be completely fulfilled with one or more subsequent purchases. This way, the consumer can combine receipts from different purchases to complete the criteria for an offer. For example, such an offer could be “buy at least 15 litres of milk of brand A in a month and receive $3”.

In this example, the consumer 160 can be permitted to combine the bundled products from different retailers if the offer is created by the manufacturer itself, such as the Coca-Cola Company. In this case the server 120 matches text data elements from the receipt of the first purchase and these text data elements match only some of the predetermined criteria of a consumer offer. The server 120 then sends information relating to the consumer offer and an indication of the predetermined criteria to yet met to the consumer device 120 which receives the information and displays the information to the consumer 160. An example for this information is “You have purchased 9 litres of milk of brand A so far and you need to purchase 6 more litres in order to qualify for this offer”.

In a different example, the product has a unique code that the consumer 160 needs to provide in order to qualify for the offer, which allows lottery style promotions.

In one example, the qualifying offers are identified from all available offers while in a different example, the consumer 160 first selects one or more offers and the qualifying offers are identified from these one or more consumer selected offers. In the second example, the consumer 160 lodges a claim and the claim is validated based on the text data elements extracted from the image of the receipt.

The consumer device 120 can automatically generate and lodge the claim based on a shopping list that the consumer 160 created before the purchase so that the consumer can see what offers the consumer will satisfy if the consumer purchases the products in the list. This way, it is possible for the consumer 160 to scan a receipt 130 and the consumer device 120 finds any consumer offers that are included among purchases.

In another example, the consumer device 110 presents to the consumer 160 a list of offers before the purchase and the consumer 160 selects one or more of these offers. The consumer device 120 then automatically adds the products of the selected offers to the shopping list. This way, the consumer 160 can receive offers that are created directly by the producer, such as the Coca-Cola Company, but the purchase is completed at an arbitrary retailer, such as a supermarket or a convenience store.

The claim lodged by the consumer 160 is validated, that is qualifying consumer offers are identified, after the purchase when the consumer captures the purchase information and sends the graphical representation of the purchase information to the server 120. The server 120 receives the graphical representation of the purchase information and extracts text data elements relating to the purchase. The server 120 then matches the text data elements to criteria of those consumer offers that the consumer 160 has previously selected. The server 120 performs the matching to identify qualifying offers, such that the criteria of the qualifying offer is successfully matched to the data elements. Of course, the consumer offers to which the text data elements are matched can be a combination of offers selected by the consumer 160 and offers provided automatically or by a third party.

After the matching 226 the server 120 sends 228 to the consumer information relating to the qualifying offers. In one example, this information is a listing of all offers where the criteria is successfully matched to the text data elements of the captured purchase information. The server 120 stores on the data memory 128 records including text data elements of previous purchases made by the consumer 160. In one example, these records are associated with the consumer 160 by a consumer ID that is stored with each record in a data base, such as SQL.

In this way, when consumer 160 wishes to combine receipts from multiple purchases, the server 120 retrieves text data elements of previous purchases from the data base when the next graphical representation of purchase information is received. The server 120 matches the text data elements from the previous purchase together with the text data elements extracted from the received electronic graphical representation of purchase information to the criteria of the consumer offers. The server 120 identifies qualifying offers, such that the criteria of the qualifying offers is successfully matched to the combined data elements including data elements extracted from multiple received electronic representations of purchase information.

The consumer device 110 receives 206 the information relating to one or more consumer offers at the input/output port. The consumer device 110 can then present to the consumer 160 the option of accepting or rejecting the offer. When the consumer 160 accepts the offer, the consumer device 110 sends a confirmation message to the server 120 and the server 120 stores confirmation data on data store 128. This confirmation data can include a reward, such as an amount that is to be added to the account balance of the consumer 160. The consumer 160 can direct the server 120 to transfer the entire account balance to a bank account of the consumer 160.

FIGS. 5a and 5b illustrate sample user interfaces displayed on a consumer device. In this example, when a receipt is captured by camera 112 as illustrated in FIG. 5a the resulting image or captured information is displayed for the consumer 160 as illustrated in FIG. 5b to check and confirm it is clear and easily readable. When submitted, it is sent to server 120, where the validation data, including the description of the offer items, is extracted, matched against the offer database and validated. In one example, the consumer device 110 requests the consumer 160 to provide additional information, such as the name of the retailer or the date of the purchase if it is not possible to extract this information from the captured receipt.

Within a predetermined time, such as 1 minute, the consumer 160 will receive a confirmation screen, displaying the detected claim items and confirming the total value of the accepted claim. The claim confirmation screen allows the consumer 160 to confirm and agree that the claim has been identified in full.

Under ‘Missing Items’ any items that were claimed and not validated will be listed together with a reason. The consumer 160 can go back and check the receipt image. If the consumer 160 can see what the consumer 160 believes is a valid offer item that has not been detected, the consumer 160 can highlight the offer item or submit an appeal in text. The Claim will then be submitted for manual validation check and response to the consumer 160.

It will be appreciated by persons skilled in the art that numerous variations and/or modifications can be made to the specific embodiments without departing from the scope as defined in the claims.

It should be understood that the techniques of the present disclosure might be implemented using a variety of technologies. For example, the methods described herein can be implemented by a series of computer executable instructions residing on a suitable computer readable medium. Suitable computer readable media can include volatile (e.g. RAM) and/or non-volatile (e.g. ROM, disk) memory, carrier waves and transmission media. Exemplary carrier waves can take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A computer-implemented method for identifying qualifying consumer offers, the method comprising:
(a) receiving an electronic graphical representation of purchase information;
(b) extracting from the graphical representation text data elements relating to the purchase;
(c) matching the text data elements to criteria of one or more consumer offers to identify qualifying offers, such that predetermined criteria of the qualifying offer is successfully matched to the data elements; and
(d) sending or displaying to the consumer information relating to the qualifying consumer offers.

2. The computer-implemented method of claim 1, wherein step (b) comprises automatically extracting text data elements using a template that identifies the relative location of the text data elements in the graphical representation.

3. The computer-implemented method of claim 2, wherein the template is specific to the retailer that originally produced the purchase information.

4. The computer-implemented method of claim 2, wherein the template is specific to the type of graphical representation of the purchase information.

5. The computer-implemented method of claim 1, wherein the data elements include two or more of:
retailer,
specific store,
operator that assisted with purchase,
point of sale used,
time,
one or more products or services purchased,
one or more price of products or services purchases,
total purchase value,
consumer identifier, and
geo-location reference.

6. The computer-implemented method of claim 1, further comprising the step of (f) storing on a data store the text data elements associated with the consumer.

7. Tangible and non-transitory computer-readable media, that when read by a computer causes the computer perform the method of claim 1.

8. A computer system for identifying qualifying consumer offers, the system comprising:
an input port adapted and configured to receive an electronic graphical representation of purchase information;
a processor adapted and configured to extract from the graphical representation text data elements relating to the purchase and to match the text data elements to criteria of one or more consumer offers to identify qualifying offers, such that predetermined criteria of the qualifying offer is successfully matched to the data elements; and
an output port adapted and configured to send or a display adapted and configured to display to the consumer information relating to the qualifying consumer offers.

9. A computer-implemented method for identifying qualifying consumer offers, the method comprising:
(a) capturing a graphical representation of purchase information, the graphical representation having extractable text data elements relating to the purchase;
(b) sending the graphical representation to a third party; and
(c) if the text data elements match predetermined criteria of a consumer offer, receiving information relating to the consumer offer.

10. The computer-implemented method of claim 9, wherein step (a) comprises taking a photograph of the purchase information.

11. The computer-implemented method of claim 9, wherein steps (a), (b) and (c) are performed by the same portable device.

12. A computer-implemented method of any one of claim 9, wherein the purchase information is a printed receipt showing itemised text based information relating to the purchase of goods or services.

13. The computer-implemented method of any one of claim 9, wherein if the text data elements match only some of the predetermined criteria of a further consumer offer, the method comprises the further step of receiving information relating to the further consumer offer and an indication of the predetermined criteria not yet met.

14. Tangible and non-transitory computer-readable media, that when read by a computer causes the computer to perform the method of claim 9.

15. A computer system for identifying qualifying consumer offers, the system comprising:
an image sensor adapted and configured to capture a graphical representation of purchase information, the graphical representation having extractable text data elements relating to the purchase;
an output port adapted and configured to send the graphical representation to a third party; and
an input port adapted and configured to receive information relating to the consumer offer if the text data elements match predetermined criteria of a consumer offer.
